(19) United States
(12) Patent Application Publication
(10) Pub. No.: US 2008/0222255 A1
(43) Pub. Date: Sep. 11, 2008

(54) Systems and methods for providing high performance and scalable messaging

(76) Inventor: Andrew Douglass Hall, Atherton, CA (US)

Correspondence Address: TRAN & ASSOCIATES, 6768 MEADOW VISTA CT., SAN JOSE, CA, 95135, US

(21) Appl. No.: 11/715,589

(22) Filed: Mar. 8, 2007

(51) Int. Cl. G06F 15/16; G06F 9/44

(52) U.S. Cl. 709/206; 719/314

(57) ABSTRACT

Systems and methods are disclosed to perform messaging among a plurality of mobile nodes by performing one disk seek to store a predetermined short message; and performing two disk seeks to read and delete the predetermined short message.

### BACKGROUND

In a typical, large modern enterprise, multiple applications are used to support various business functions. These applications may need to exchange information in order to keep data within each application consistent across the enterprise. For instance, there may be a Web Application which collects information entered by customers, there may be a Customer Relationship Management (CRM) system that maintains information about customers and there may be a Financial System that maintains information about customers and their accounts. Whenever a customer record is updated in one of these systems, the other systems need to be informed. One way of solving this problem is to have the applications exchange messages using a Message Exchange System.

FIG. 1 shows an exemplary architecture where application servers communicate through a Message Exchange System. In FIG. 1, a portable laptop 10 communicates over a network 20 such as the Internet. The laptop 10 communicates with a Web Application Server 30, which in turn communicates with a Message Exchange System 32. The Message Exchange System 32 in turn communicates with a Customer Relationship Management (CRM) server 34 and a Finance Server 36, for example. The advantage of this type of architecture is that the applications can operate more of less independently of each other. If any one of the applications should go off-line, the messages destined for that application are held in queues in the Message Exchange System 32 until the application becomes operational again. In a typical scenario, the number of queues being managed is reasonably small and roughly proportional to the number of enterprise applications.

In principle, this architecture can be used to extend communications to occasionally connected mobile devices with addition of a Mobile Communications Server 40 which handles the transmission of message to and from mobile devices 10, 42 and 44 and the exchange of these messages with the Message Exchange System 32 as shown in FIG. 2.

However, there are several issues with this architecture. First and foremost, the number of devices supported can range from a few hundred devices to tens of thousands devices depending on the size of the enterprise. In the simplest implementation, there might be one inbound message queue and one outbound message queue per device, which would mean the Message Exchange System 32 would have to scale to handle twice as many queues as there are devices. Most commercially available message queuing systems simply do not scale to handle such large number of queues.

To overcome this problem, one might consider assigning multiple devices to single input and output queues. While this would seem to address the problem with large numbers of queues, what happens is the number of messages in the queues can get large and the queue operations of search and delete can take an excessive amount of time. This severely degrades the throughput and responsiveness of the system.

Furthermore, there are applications where it is desirable to interface the Mobile Communications Server directly with one or more of the back-end systems and bypass the Message Exchange System altogether. A better approach is to embed a message queuing system into the Mobile Communications Server which is designed specifically to meet the scalability and performance requirements necessary to support large numbers of mobile devices and provide for alternative interfaces into the enterprise systems.

### SUMMARY

In one aspect, a process to perform messaging among a plurality of mobile nodes, includes performing one disk seek to en-queue, read or de-queue a predetermined short message. With long messages two disk seeks may be necessary to en-queue or read a message.

Implementations of the above aspect may include one or more of the following. The size of a predetermined short message is configurable and is typically between one kilobyte and four kilobytes, but is otherwise arbitray. A disk or data storage device can be kept in a consistent state so that in case of program or operating system failure, messages in the data store can be recovered. A data store can use one or more files of a file system or raw disk partitions. The system can use an operating system provided disk buffer cache to avoid disk seeks and improve performance. A disk allocation scheme based on a buddy scheme can be used. Space can be allocated by removing an entry for a disk region from a free list of regions and marking the region as allocated. The system can perform I/O operations to allocated regions in parallel. The system can mark a region as allocated at the same time data is written into the region. The region can be de-allocated by marking the region as free and adding the region to the free list. A message can be stored in one or more contiguous disk blocks. The system minimizes the number of disk seeks required to en-queue, read or de-queue a message. The system initializes the data store and message queues by examining each region in the data store. The system reconstructs data objects contained in allocated regions and adds them to message queues and alternatively adds unallocated regions to the free lists. The system can perform garbage collection. The garbage collection process can include combining buddy regions in the free list into larger regions. The system allows multiple simultaneous operations on queues.

Advantages of the system may include one or more of the following. The system embeds a message queuing system into the Mobile Communications Server which is designed specifically to meet the scalability and performance requirements and provide for alternative interfaces into the enterprise systems. The Message Queuing System is scalable in both size and performance across a wide range of computer operating environments. The architecture is such that the same Application Programming Interface (API) is made available on devices ranging from small mobile devices to large enterprise servers. Because of the wide range of computing environments, including programming languages, available system memory and CPU capacities, the architecture also permits a wide variety of underlying implementations while maintaining identical APIs across all environments.

The Message Queuing System can be implemented on multiple types of handheld computers and cellular telephones where memory and CPU power are somewhat limited and it is only necessary to manage 2-3 queues. The Message Queuing System can also be implemented on large servers where it is necessary to handle tens of thousands of queues each potentially containing hundreds of messages.

The system minimizes the amount disk activity required to en-queue, read and de-queue persistent messages and keeps the time required to store, read or delete a message constant as load increases. Scalability is achieved by allowing disk activity to be spread across as many independent disk drives a needed to achieve the desired performance. In addition, the design scales from small handheld devices to large-scale enterprise applications. The result is a high-performance, scalable, message queuing system that achieves a number of features. For example, the time taken by the basic queuing operations: queue look-up, en-queue and de-queue is independent of the number of queues or the number of messages in the queues. The number of backing store operations required to en-queue, read or de-queue a message, is the minimum required. That is, one or two disk seeks and write operations to en-queue or read a message depending on length, and one disk seek and write operation to de-queue a message. En-queue, read and de-queue operations on a single backing-store device can be carried out in parallel. A write-through disk buffer cache can be used to improve performance. The state of the data store is consistent at all times, even after CPU or OS failure. By simply adding CPU, memory and disk storage capacity, it is possible to scale the system to handle large numbers of queues and messages and increase the message processing rates.

### BRIEF DESCRIPTION OF THE FIGURES

FIG. 1 shows an exemplary prior art architecture for a messaging system.

FIG. 2 shows a prior art messaging system that can handle mobile devices such as cell phones.

FIG. 3 shows an exemplary system architecture and a Messaging System.

FIG. 4 shows an exemplary architecture of the Message Queuing System.

FIG. 5 shows an exemplary message representation.

FIG. 6 shows an exemplary queue representation.

FIG. 7 shows an exemplary message after initial creation.

FIG. 8 shows an exemplary empty queue after initial creation.

FIG. 9 shows an exemplary message after the first step on an en-queuing operation.

FIG. 10 shows an exemplary queue entry after the second step of an en-queuing operation.

FIG. 11 shows an exemplary queue after the third and final step of an en-queuing operation.

FIG. 12 shows an exemplary empty queue after removing a message.

FIG. 13 shows an exemplary file store after initialization.

FIG. 14 shows an exemplary file store after several allocations and de-allocations.

FIG. 15 shows an exemplary region descriptor used by the file store.

FIG. 16 shows an exemplary queue entry returned by the file store.

FIG. 17 shows an exemplary region descriptor used by the RMS store.

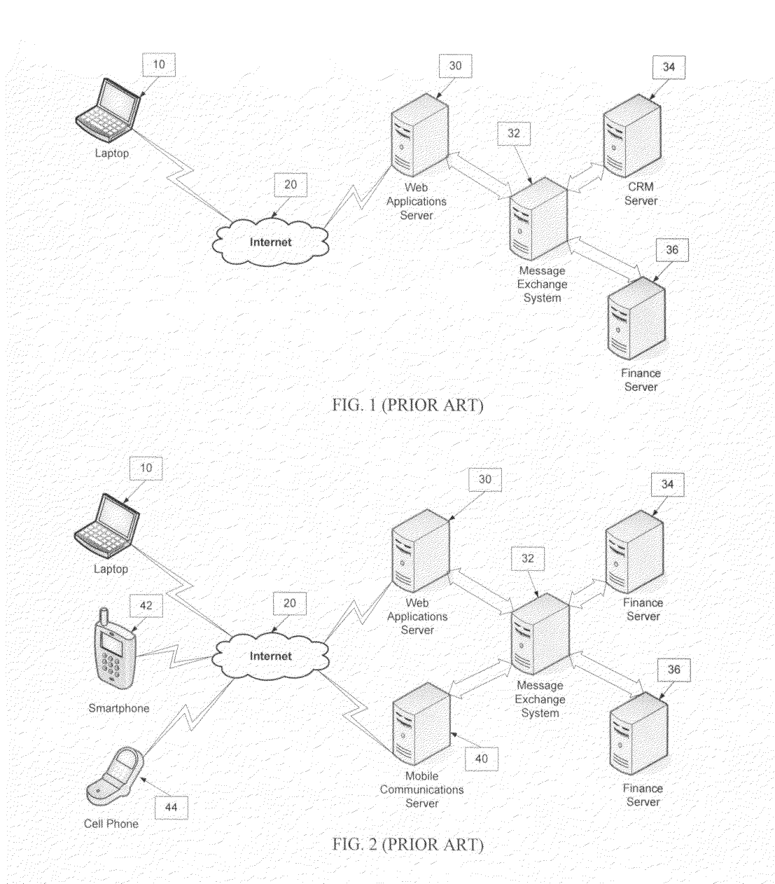

### DESCRIPTION

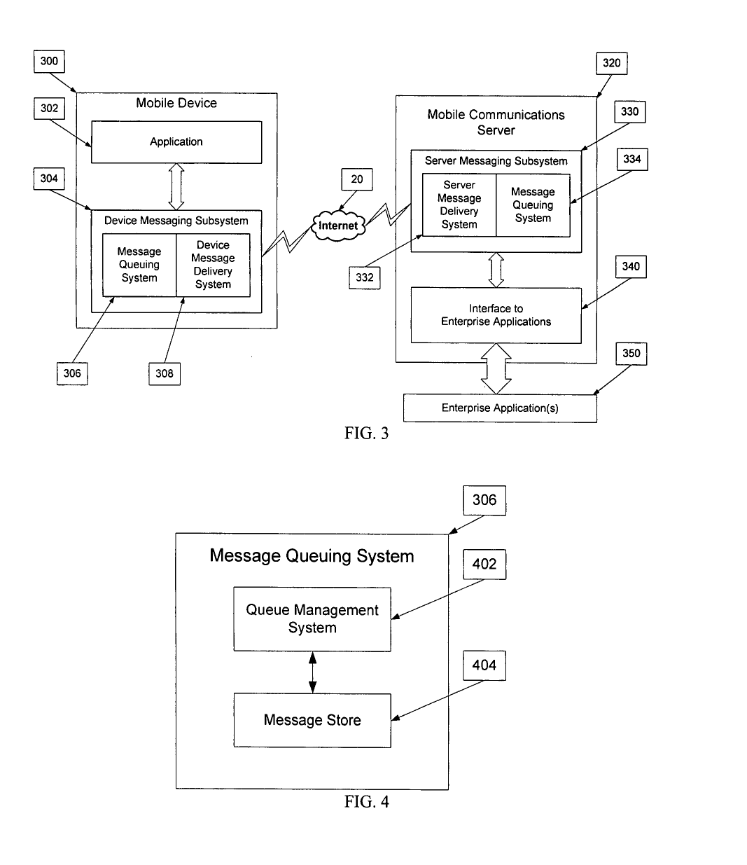

The overall system architecture is shown in FIG. 3 illustrating a Mobile Device 300 communicating with a Mobile Communications Server 320 over the Internet 20. An application 302 on the device 300 communicates with a Device Messaging Subsystem 304 which contains a Message Queuing System 306 and a Device Message Delivery System 308. Similarly, the Interface to Enterprise Applications 340 in the Mobile communications Server 320 communicates with a Server Messaging Subsystem 330 which itself contains a Message Queuing System 334 and a Server Message Delivery System 332. The Message Delivery Systems 308 and 332 in the Mobile Device and in the Mobile Communications Server 320 are different, but the Message Queuing Systems 306 and 334 provide identical interfaces to the Messaging Subsystems 304 and 330.

The architecture of the Message Queuing System 306 or 334 is shown in FIG. 4. There are two principal components: a Message Store 404 and a Queue Management System 402. Throughout the descriptions which follow, an object-like representation is used but other implementations are possible. Here, objects simply contain properties that are primitive values such as integers, strings or pointers to other objects. Other representations are possible, but this is the most convenient for descriptive purposes. Also, many implementation details are omitted here in order to simplify the description of the operation.

The Message Store 404 provides the underlying storage mechanism for messages that are held in the queues by the Queue Management System 402. The APIs (interface) provided by instances of Message Stores are identical across all implementations, but the underlying implementation details vary depending on the desired performance characteristics and the underlying persistent storage mechanisms. There are three embodiments of a Message Store:
Memory Message Store—This implementation stores all messages held in the queues in memory. This provides very fast en-queuing and de-queuing operations. However, messages are not stored in a persistent memory device and if the system should be shutdown or unexpectedly crash, all messages would be lost. A Memory Message Store is created as follows:
   MessageStore msgStore=new MemoryStore( );
File Message Store—This is the typical implementation on systems that provides random access disk files. A simple implementation, suitable for mobile devices, uses a single random access file to implement the Message Store. A high-performance server-based implementation might use several random access files each on a different disk drive allowing multiple disk operations to proceed in parallel. If the underlying operating system supports disk buffer caching, then very high performance is achievable even on a single disk. A File Message store is created as follows:
   MessageStore msgStore=new FileStore(String name);
RMS Message Store—Some programming environments do not provide random access files, and instead provide a form of indexed access called a Record Management System (RMS). In this case, when a record representing a message is inserted into the store, an index (or handle) is returned that allows later access to the record content or allows the record to be deleted. An RMS Message Store is created as follows
   MessageStore msgStore=new RMSStore(String name);

The Queue Management System 402 provides the basic APIs available to the Messaging Subsystem 304 on the Mobile Device 300 and the on Mobile Communications Server 320. The APIs and implementations are identical across all mobile devices. One embodiment of the Queue Management System has the following characteristics:
1. Scaling—The Queue Management System 402 scales from supporting 3-4 queues on a Mobile Device 300 to tens of thousands of queues in the Mobile Communications System. This basic properties are:
   a. Queue lookup, which is by name, takes a constant amount of time regardless of the number of queues.
   b. Memory consumption is proportional to the number of queues and the total number of messages in a queue.
   c. The amount of memory consumed by an empty queue is on the order of 170 bytes.
   d. For a File Message Store, the amount of memory consumed by a queued message is on the order of 40 bytes. For a Memory Message Store the amount of memory consumed is obviously dependent on the size of the message and for an RMS Message Store the memory consumed by a queued message is on the order of 12 bytes.
2. Priority—The Queue Management System 402 supports message prioritization within a queue. Messages of the same priority are handled on a first-in first-out basis.
3. En-queue and De-queue Operations—Ideally, en-queuing and de-queuing operations should take a constant amount of time. However, there is a trade-off between memory consumption and speed. While implementations are possible that provide constant time en-queuing and de-queuing operations, complex data structures are required.

In the embodiment described here, a queue representation is selected that minimizes the memory consumption at the expense of the time to en-queue a message. However, in practice, this loss is negligible. In the typical case where the queue is empty or contains messages of the same priority, en-queuing and de-queuing operations take a constant amount of time. If the queue contains messages of mixed priority, then en-queuing can take an amount of time proportional to the length of the queue. Because the queues are typically very short and don't often contain mixed priorities, this time is negligible and is dominated by other processing times. Implementations with constant time en-queuing are possible, but use considerably more memory.

To make it possible for there to be one implementation of the Queue Management System 420 that supports multiple implementations of the Message Store 404, a simple interface is defined that allows the Queue Management System to interact with the Message Store without having any knowledge of the underlying implementation. To do this, the Queue Messaging System 402 and the Message Store 404 exchange two objects: a Message and a Queue Entry as described in more details below.

In one embodiment, a message object is created as follows:

Message message=new Message(byte[ ] messageBody);

where the byte array, messageBody, is application defined.

FIG. 5 shows an exemplary message object resulting from this call. The Message representation includes one or more system properties 502, which are pointed to by a message 504. The Message 504 also points to one or more Message Properties 508 and a Message Body 506. An application creating a Message 504 passes in a byte array representing the message content which is stored in the Message Body 506. An application can also define and set an arbitrary number of Message Properties 508 that are to be associated with the message. The Queue Management System 402 ensures that the Message Properties 508 and Message Body 506 are preserved through en-queuing, read and de-queuing operations. In addition to-the application defined Message Properties 508, a Message 504 carries along a set of System Properties 502 that includes the Queue Name, Message ID, Time Stamp, Message Sequence Number, and Message Priority. An application can access these quantities but not change them. The key here is the System Properties contain all the information necessary to reconstruct queues from messages contained in a Message Store.

A Queue is created by invoking the getQueue API provided by all Message Stores as follows:

Queue queue=msgStore.getQueue(String name);

A simple hash table is used to map queue names to queues. This provides constant time lookup of queues.

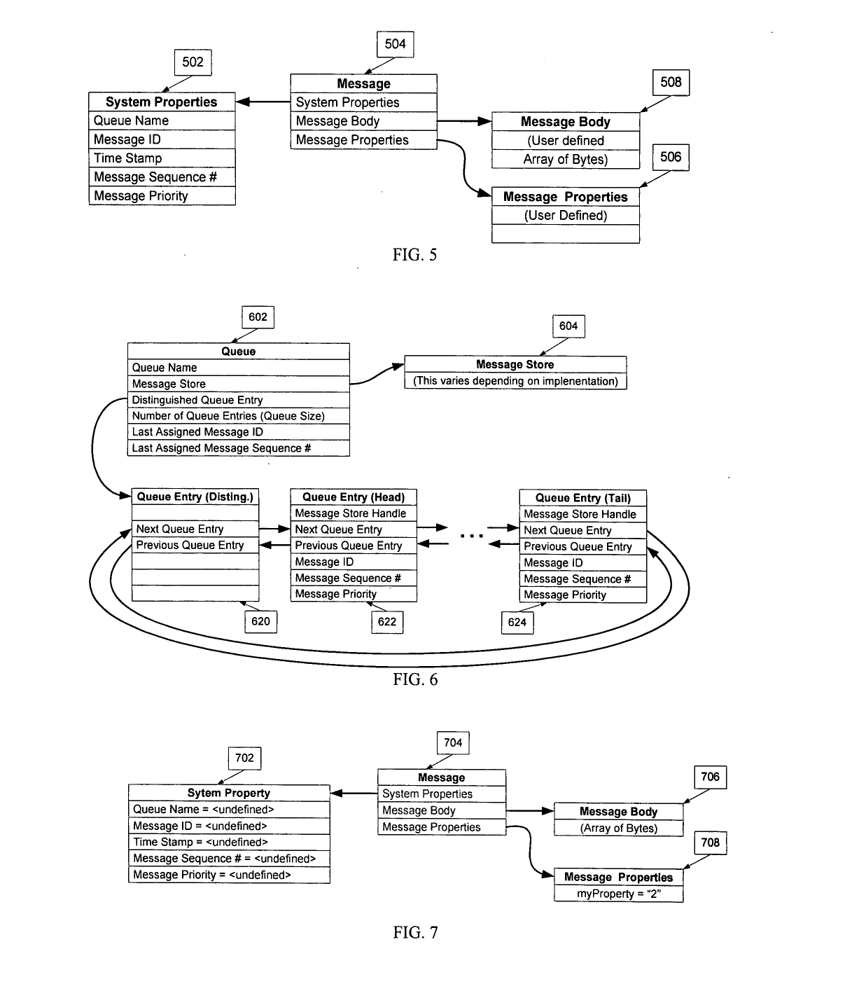

A Queue 602 is represented as shown in FIG. 6. The Queue 602 has a Distinguished Queue Entry pointer to a Distinguished Queue Entry 620 which itself contains a Next Queue Entry pointer pointing to the Head Queue Entry 622 and Previous Queue Entry pointer to the Tail Queue Entry 624. The six properties associated with the Queue 602 are thus as follows:
Queue Name—This is the string representing the name of the Queue. It is assigned by the application when a Queue is created.
Message Store—This is a pointer to the object implementing the particular Message Store being used. It provides access to the Message Store APIs needed when performing the en-queue, read and de-queue operations on a queue.
Distinguished Queue Entry—This is a pointer to an empty Queue Entry which provides access to the head and tail of the queue. This Queue Entry is not an actual member of the queue but serves to simplify the insertion or deletion of Queue Entries.
Queue Size—This simply is a count of the number of Queue Entries.
Last Assigned Message ID—This is used to ensure that every Message inserted into a queue is assigned a unique Message ID.
Last Assigned Sequence #—As messages are inserted into the queues, they are assigned a sequence number. This together with the application defined priority determines the relative position of the Queue Entry in the Queue.

There are also six properties associated with each of Queue Entries 620, 622, and 624, including:
Message Store handle—This is a pointer to an object created by the Message Store implementation being used. It holds information used by the Message Store to locate Messages held within the Message Store.
Next Queue Entry—A pointer to the next Queue Entry. That is, moving from the head to the tail of the queue.
Previous Queue Entry—A pointer to the previous Queue Entry. That is, moving from the tail to the head of the Queue.
Message ID—This is the unique Message ID assigned to the Message when it is en-queued.
Message Sequence #—This is the message sequence number assigned to the Message when it is en-queued.
Message Priority—This is the priority assigned to a Message when it is en-queued.

The Queue Entry at the head of the queue can be found by following the Next Queue Entry pointer in the Distinguished Queue Entry. The Queue Entry at the tail of the queue can be found by following the Previous Queue Entry pointer in the Distinguished Queue Entry.

Once a Message Store is created, the following application programming interfaces (APIs) are available as follows:

Queue getQueue(String name)
This takes the name of a queue as a String and returns the Queue with the given name, creating it if necessary.

QueueEntry putMessage(Message message)
This takes a Message and inserts it into the Message Store. Prior to making the call, the Queue Management System fills in the Message ID, the Message Sequence Number and the Message Priority in the System Properties of the Message. The call returns a QueueEntry with the Message Store Handle filled in and copies of Message ID, Message Sequence # and Message Priority taken from the System Properties associated with the message.

Message getMessage(QueueEntry queueEntry)
This takes a QueueEntry and returns the Message corresponding to the QueueEntry

void deleteMessage(QueueEntry queueEntry)
This takes a QueueEntry and deletes the associated Message from the Message Store.

void close( )
This performs whatever cleanup operations are needed to gracefully shutdown a Message Store.
   The four basic operations on a Queue are as follows:

void addMesage(Message message, int priority)
This inserts a message into the Queue behind all others with equal or higher priority and ahead of those with lower priority. Note that if all the messages in the Queue have the same priority as the incoming message, then the incoming message will be added to the tail of the Queue in constant time. Because the message can be added to the associated Message Store in constant time, addMessage will take constant time.

Message peekMessage(int priorityThreshold)
This returns the first Message in the Queue with priority equal to or greater than the priorityThreshold. If such a Message does not exist, null is returned. Note here that only the Message at the head of the Queue need be examined. It either meets the criteria or not. If not, then all other Messages in the Queue do not meet the criteria. Thus, this operation takes constant time.

boolean deleteMessage(String messageID)
This deletes the Message from the Queue with matching messagelD. Returns true if a message was deleted. Otherwise returns false. This is most often used in conjunction with peekMessage and thus deletes the Message at the head of the Queue in constant time.

int getSize( )
This returns the number of entries in the Queue. Because this count is kept as property of the Queue this operation takes constant time.
   Other utility operations are provided. These are typically used in administrative applications that examine or otherwise administer queues and their contents. They are infrequently used and it is not important that they run particularly fast. They are included here only for completeness.

Message getMessage(String messageID)
This returns the Message with matching messageID. If such a Message does not exist, null is returned.

int countMessages(int minPriority, int maxPriority)
This returns the number of messages in the Queue with priority greater than or equal to minPriority and less than or equal to maxPriority.

Message[ ] peekAll( )
This returns an array of Messages containing all the messages in the Queue.

void deleteAll( )
This deletes all messages in the Queue.

string getName( )
This returns the name of the Queue.

Because the operation of the Queue Management System 306 is independent of the implementation of the Message Store, the operation is illustrated assuming a Memory Message Store and the differences are described when using a File Message Store or RMS Message Store. Assuming a Memory Message Store has been created, the steps are as follows:
1. Create an initial Message object passing in a byte array and setting one user defined message property, “myProperty”, with a value of 2. The calls are as follows:

Message message = new Message(byteArray);
message.setIntProperty(“myProperty”, 2);

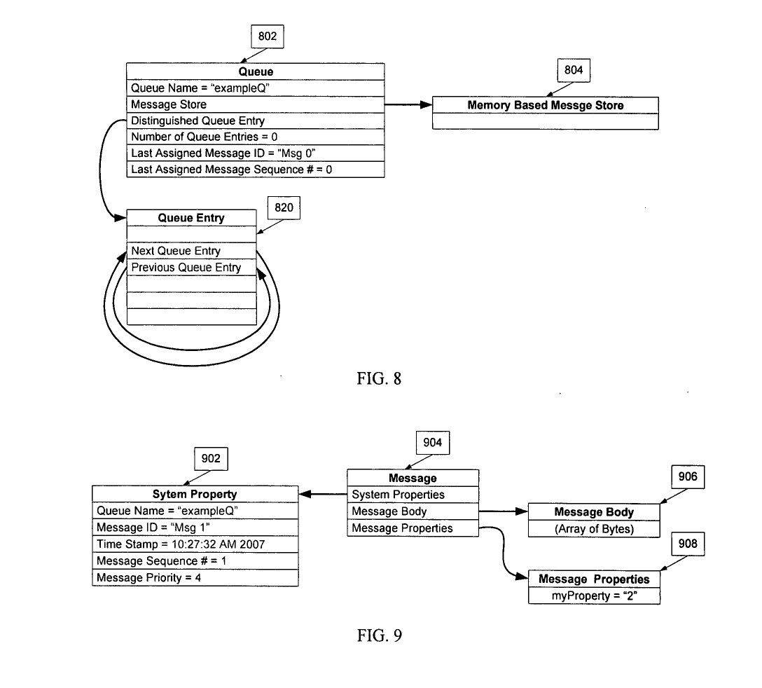

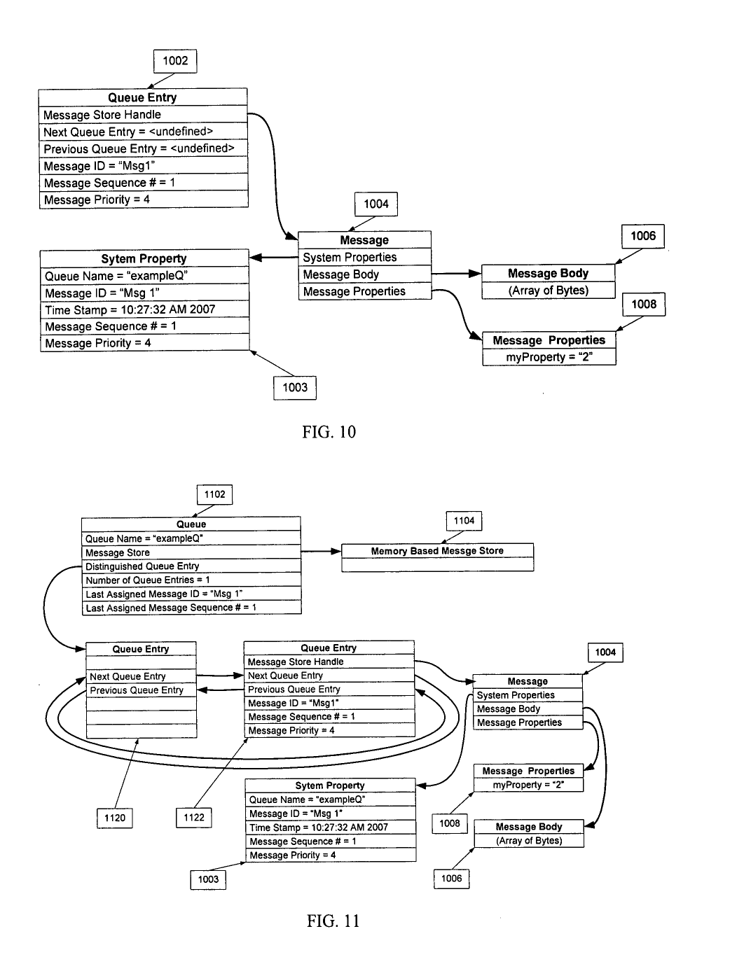

The resulting Message 704 is as shown in FIG. 7. Only the Message Properties 708 and the byte array in the Message Body 706 will be filled in at this point.
2. Obtain the queue into which the message will be inserted. Call it “exampleQ”. It is assumed that the queue does not exist and will be created by the call to get the queue as follows:
   Queue exampleQ=msgStore.getQueue(“exampleQ”);
The queue returned 802 and assigned to exampleQ is shown in FIG. 8.
3. Now, use the following call to insert the message into exampleQ with priority 4.
   exampleQ.addMesage(message, 4);
There are several intermediate steps taken by addMessage. First the Queue Management system fills in the System Properties 902 in the Message as shown in FIG. 9.
Next the Queue Management System calls the associated Message Store putMessage API with message as a parameter and obtains a QueueEntry object queueEntry by making the following call:
   QueueEntry queueEntry=msgStore.putMessage(message);
This QueueEntry returned and assigned to queueEntry is shown in FIG. 10.
Finally, the Queue Management System inserts the Queue Entry into the queue. The resulting queue structure 1102 is as shown in FIG. 11.

Note that the Number of Queue Entries, the Last Assigned Message ID and the Last Assigned Sequence # properties in Queue 1102 have been updated.

The message can be de-queued in three steps as follows.
1. First, get the message at the head of the queue with the following call:
   Message message=exampleQ.peekMessage(0);
2. Next, get the MessageID from the message,
   String messageID=message.getMessageID( );
3. Finally, delete the message from the queue.
   exmapleQ.deleteMessage(messageID);

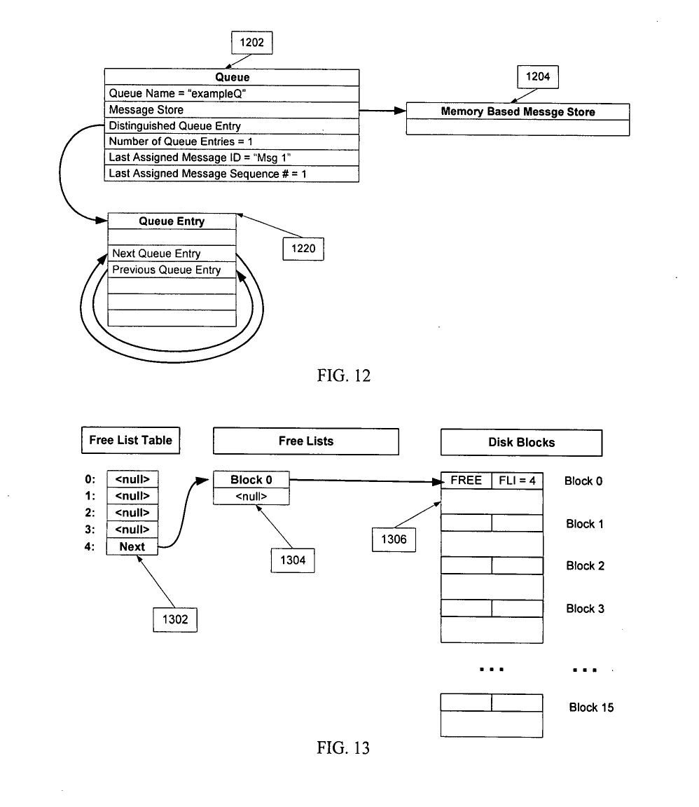

The deleteMessage API involves two intermediate steps. First the Queue Management System locates the corresponding QueueEntry and removes it from the queue. Call it queueEntry. Then the Message Store is called to remove the Message from the Message store, as follows:
msgStore.deleteMessage(queueEntry);
   The resulting state of the queue 1202 is shown in FIG. 12.

### File Message Store

Next, one implementation of the Message Store called the File Message Store 404 is described in more detail. Assume that the system must support 100,000 mobile devices and that the messaging sub-system will be required to persistently store 20 1,000 byte messages for each device at the same time. This means that 2 gigabytes (2×10⁹ bytes) of storage will be required for all messages. This is well within the capacity of disk technology, so this is not a limitation.

Now to deliver all of these messages in a 1 hour period would require delivering roughly 600 messages per second and sustaining a data transfer rate of 600 kilobytes of per second. This data rate is well below the transfer rate of most disk drives and certainly below network capacities so this also is not a limitation.

The gating factor turns out to be the disk seek time. The File Message Store is designed so that for “short” messages, the add, read and delete operations are completed using one disk seek. For “long” messages, the add and read operations are completed in 2 seeks. However, for the applications envisioned here, the File Message Store can be configured so that the most messages are considered to be short, thus achieving a near minimum number of disk seeks.

A good SCSI disk drive has an average read/write time around 5 ms and a maximum read/write time of around 10 ms. or between 100 and 200 operations per second. If “short” messages are stored, then the system needs to be able to achieve 600 seeks per second in order to sustain the delivery rate of 600 messages per second. Thus, on average three disk drives would be needed. However, this assumes that every operation on the File Message Store requires an actual disk seek. If disk buffer caching is used, one can significantly reduce the number of actual seeks required, so it is possible for the File Message Store to achieve performance on the order of 3500 en-queue, read and de-queue operations per second on a single disk drive.

Next, an exemplary simple message store is described that in steady state requires a minimum of 1 disk seek to add, read and delete a short message. Here, “short” is a configurable number usually in the range of about 1 kilobyte-4 kilobytes depending on the underlying operating system but is otherwise arbitrary. Long messages may require 2 disk seeks to store or read a message, but only one disk seek to delete the message.

To achieve maximum performance, the system ensures that:
1. A message is stored in contiguous blocks on disk. If this is not the case, multiple seeks might be required to read or write long messages.
2. The disk file is always in a consistent state so that in case of program or operating system failure, the messages can either be recovered or corrupted messages detected and deleted.

In addition, the system preserves the option of creating the message store in files in a traditional file system or on a raw disk partition depending on the underlying characteristics of the operating system. On some operating systems, accessing a raw partition can give greater control over disk I/O and hence better performance. On others, the use of the operating system's disk buffer cache can yield better performance.

The simplest approach is to adapt a memory allocation technique based on the buddy system (cf. K. C. Knowlton, “A Fast Storage Allocator,” Comm. ACM, Vol. 8, pp. 623-625, October 1965.) to this problem.

A simplified example is used to illustrate the basic principles and in later sections describe the implementation of the File Message Store and the integration with the Queue Management System described earlier.

This scheme is easiest to understand by taking a simple example and then dealing with the variations. The system starts with a disk file consisting of 2^{N} blocks addressed with block numbers 0, 1 . . . 2^{N}−1. The block size will typically match the physical block size used by the underlying operating system, often 1 kilobyte or 4 kilobytes. On small mobile devices, one might use something smaller but no less than the predominant message size.

The system begins by constructing N+1 free lists for disk regions of size 2⁰ to 2^{N} blocks. The free lists are identified by their free list index, 0, 1, . . . N, respectively and are initially empty. To get started, the system simply writes in the first few bytes of block 0, a flag indicating the region is free and the free list index, N, and adds block 0 to the free list of regions of size 2^{N}.

After this initial step, the data structure for a File Message Store of 16 disk blocks would look as shown in FIG. 13. Note that the single free list 1304 is located at index 4 in the Free List Table 1302 and that the free list index, 4, appears at the beginning of the first block (block 0) 1306 of the region on disk. It has length 2⁴=16 disk blocks.

If the system needs to store an item that requires 2^{M} blocks, it first examines the free list at index M in the Free List Table which holds the free list of regions of size 2^{M}. If the free list is empty, the system next looks on the free list for regions of size 2^{M+1} blocks. Assuming this free list is not empty, the system removes a region from this free list and splits the region into two regions each of size 2^{M}. Into the first few bytes of the second region the system writes the flag indicating the block is free and the free list index M. Then, into the first few bytes of the first region the system writes the flag indicating it is free and the free list index M. Finally the system adds the two regions to the free list of blocks of size 2^{M}. This algorithm can be applied recursively to create regions of any required size.

To perform the allocation, the system removes a block of size 2^{M} from the free list and writes into the first block of the region a flag indicating the region is allocated and the free list index, M. The consuming program is returned a Region Descriptor containing the block number and the free list index of the region allocated.

To de-allocate a region, the consuming program passes in the Region Descriptor to the message store. Using the block number from the Region Descriptor, the message store writes a flag indicating the block is free and the free list index into the first few bytes of the region and then adds the block number to the corresponding free list.

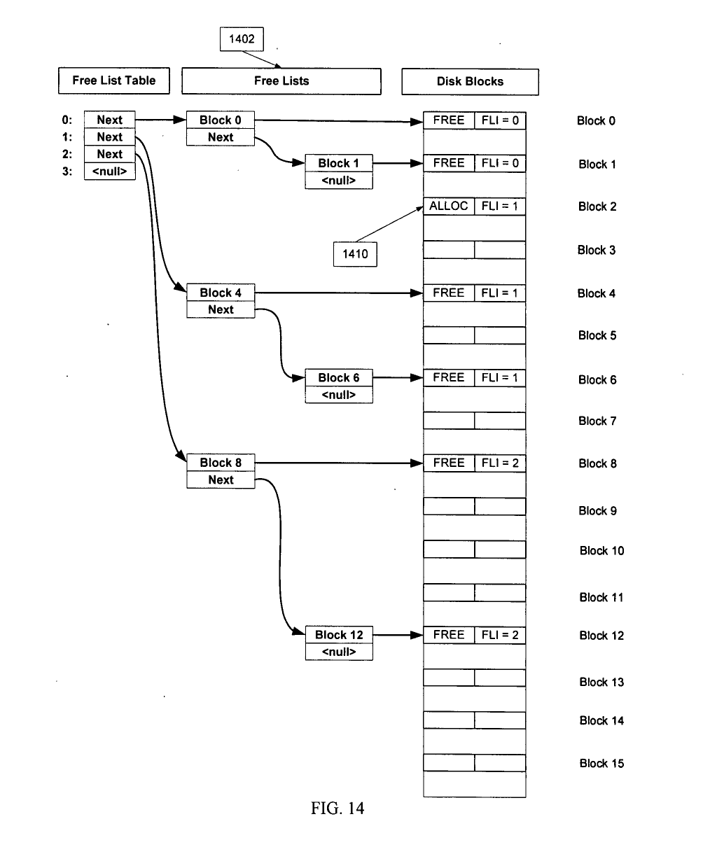

After a number of allocations and de-allocations, the File Message Store and free lists 1402 might look as shown in the example of FIG. 14.

It is not necessary to start with a file that is of size 2^{N} blocks. It is simply a matter of properly constructing the free lists and initializing the store appropriately. Some care has to be taken to make sure one can detect the difference between an incompletely initialized file and one that is completely initialized. For this reason, it is simpler to start with file of 2^{N} blocks and initialize with a single disk write to block 0.

Similarly, it is possible to enlarge the store dynamically, by adding more blocks, but again this has to be done with care to make sure that the file structure is consistent at all times. This is unnecessarily general and to ensure store consistency, it is simplest to start with a store of size 2^{N} and grow it either by doubling each time or incrementing the size by adding regions of size 2^{N}. In this way the additional space can be initialized with a single disk write.

There are several important properties of this scheme:
1. In steady state, where there are regions of sufficient size on the free lists, allocation is simply a matter of removing an entry from the free list and marking the region as allocated. Short messages can be written at the same time. This takes constant time.
2. The operations of adding, reading or deleting a message typically will take one disk seek so these operations typically take constant time. Long messages will require 2 disk seeks, but the time is still bounded.
3. Long messages are stored in contiguous disk blocks, thus minimizing the number of disk seeks required to write or read a message. Further, I/O operations on allocated regions can be carried out in parallel.
4. Because in a typical application, there are only a few messages sizes that are repeatedly moved in and out of a File Message Store, there may not be any need for real-time garbage collection.

Garbage collection is simply a process of going through the free lists and identifying regions that are buddies and combining them into larger regions. The process begins with the free list of the smallest regions and working up through the free lists of larger regions. Two regions A and B of size 2^{N} are buddies if and only if BlockNumber(A) \textcircled{x} BlockNumber(B)=2^{N}, where the \textcircled{x} operator represents bit-wise exclusive-or of the block numbers. The proof of this is left to the reader. Garbage collection is reasonably fast as the free-lists are kept in memory and only when buddies are combined is a disk write required.

Note that garbage collection will not necessarily allow one to shrink the size of the file, as the last block in the file may be a member of an allocated region. However, in actual practice there are ways around this, as follows:
1. If the File Message Store is used on a mobile device and the device is out of range, many messages may be held in the message store, causing the message store to get temporarily large. It would be nice to recover this storage, once the messages are delivered to the Mobile Communications Server 320 in FIG. 3. On a mobile device, one way to handle this is to notice when no messages exist in the message store and simply re-create the message store at a smaller size.
2. If the File Message Store is being used in a server environment, it may never make sense to perform a garbage collection. This is because the store will naturally expand to accommodate the maximum message load which will be assumed to occur on a regular basis. It may be useless work to garbage collect, recover disk space only to have the store grow again.

The actual implementation of the File Message Store only differs from the above description in the nature of the Region Descriptor. In order to integrate the message store just described with the Queue Management System, it is convenient to use a Region Descriptor that can be both a member of a free list or pointed to by the Message Store Handle in a Queue Entry.

When a Region Descriptor is a member of a free list, it serves to identify a region of the disk file that is available for allocation. In this case, it must carry the block number of the first block of the region in the file. The length of the region is determined by the free list index of the free list to which the Region Descriptor belongs. Finally, there must be a provision for the pointer to the next free list entry.

A Region Descriptor can also be pointed to by the Message Store Handle in a Queue Entry which was described earlier. In this case, it contains all the information necessary to locate the message in the File Message Store. In addition, it turns out to be convenient to carry along a revisiion number and the flag indicating whether or not the Region Descriptor represents a free or allocated region.

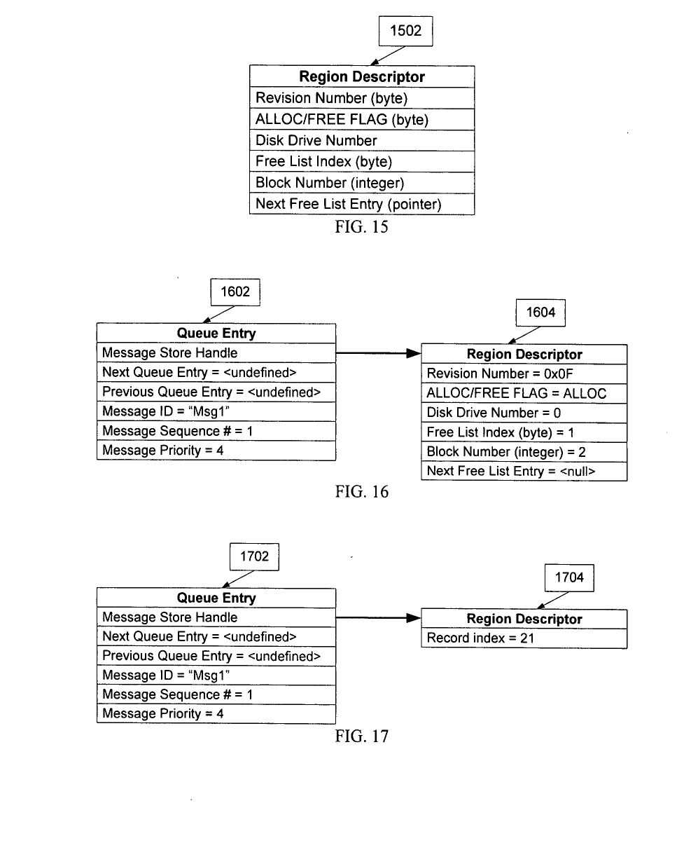

Thus in the actual implementation of the File Message Store, the properties contained in a Region Descriptor 1502 are as shown in FIG. 15

The first five properties of a Region Descriptor (8 bytes) are always written to the first 8 bytes of a free or allocated region in the file. In detail, these properties are as follows:
Revision Number—This allows the File Message Store to detect the revision of the File Message Store that created the file should the implementation of the File Message Store change.
Allocation Flag—This indicates whether or not the Region Descriptor represents a free region or an allocated region.
File Number—If multiple files or disk drives are being used, this serves to determine which file this region belongs to. When the Region Descriptor is pointed to by a Queue Entry, the file number determines which file holds the message, the block number describes the location in the file and the Free List Index determines its length.
Free List Index—The length of this region of disk is represented by this Region Descriptor is 2^{Free List Index} blocks
Block Number—The first block of the region of disk represented by this Region Descriptor.
Next Free List Entry—When a Region Descriptor is on a free list, this is a pointer to the next free list entry.

As described earlier, he three APIs for adding, reading and deleting messages that are supported by a Message Store are as follows:

QueueEntry putMessage(Message message)
This takes a Message and inserts it into the Message Store. It returns a QueueEntry with the Message Store Handle, Message ID, Message Sequence # and Message Priority taken from the System Properties of the incoming Message.

Message getMessage(QueueEntry queueEntry)
This takes a QueueEntry and returns the Message corresponding to the QueueEntry

void deleteMessage(QueueEntry queueEntry)
This takes a QueueEntry and deletes the associated Message from the Message Store.

In the case of the File Message Store, a QueueEntry 1602 returned by the putMessage API has the representation shown in FIG. 16. This represents the allocated block 1410 shown in FIG. 14. Now the only difference between the Memory Message Store and the File Message Store from the perspective of the Queue Management System is the object pointed to by the Message Store Handle in a Queue Entry. In the case of the Memory Message Store, the Message Store Handle is a pointer to the in-memory representation of a Message. In the case of the File Message Store, this is a pointer to a Region Descriptor which contains all the information needed to locate the message in the Store.

When using a File Message Store, all the structures associated with queues and free lists are held in memory will disappear when the system is shutdown. Fortunately, all the information required to bootstrap the queues and free lists are contained in the files used by the File Message Store. In order to make recovery possible, the implementation of a Queue provides one additional API that can be used by a Message Store as follows:

void insertQueueEntry(QueueEntry newEntry);

This takes a QueueEntry and inserts into a queue in the proper position based on the Priority and Message Sequence # found in the QueueEntry.

The process of recovering the state of the free lists and queues proceeds as follows in one embodiment.
1. Set a read index to block 0 of the file.
2. Read the information from the first 8 bytes of the block indexed by the read index and construct the Region Descriptor, rd, which describes this region. Recall that the first five entries of a Region Descriptor are contained the beginning of each allocated or free region.
3. If the region is free, simply add the Region Descriptor to the appropriate free list using the free list index contained in the Region Descriptor just constructed.
4. If the region is allocated, read the System Properties, sp, of the message to obtain the Queue Name, Message ID, Message Sequence # and Message Priority which were stored when the message was placed in the File Message Store. Use the Queue Name to obtain the Queue as follows
   Queue queue=getQueue(name);
Next, create a QueueEntry called queueEntry as follows:
   QueueEntry queueEntry=new QueueEntry(sp, rd);
   This resulting QueueEntry 1602 is shown in FIG. 16.
Finally, call the insertQueueEntry API in the Queue Management System.
   Queue.insertQueueEntry(queueEntry);
This will insert the QueueEntry in the proper position in the Queue. The Last Message Sequence # and the Last Message ID in the Queue will be updated to reflect the values associated with the message with the highest Message Sequence #.
5. Finally, advance to the next region by advancing the read pointer by 2^{Free List Index} blocks. Repeat the above starting at Step 2.

The state of the disk should be maintained in a consistent state at all times so that recovery in the event of a system crash is possible. However there is a trade-off between performance and the degree to which all messages are recovered. To solve this problem the File Message Store provides different strategies depending on the performance and recovery tradeoff.

Assuming the all writes to disk are synchronous and performed in the order requested by the File Message Store, the disk will always be in a consistent state. This is because the first block of any region is the last block written when changing the state from free to allocated or allocated to free. If a region is being changed from “free” to “allocated” and it is a region that contains a message that requires N blocks, then the last N−1 blocks are written first, then the first block of the region. This assures that the message content will be completely written to disk before the region is changed from free to allocated, thus keeping the whole region consistent.

However, using synchronous writes to the disk can severely degrade performance and eliminates all performance gains resulting from the use of a disk buffer cache. One mode provided by the File Message Store is to only use synchronous writes when a block is split. This assures that at least the region is marked free or allocated and the proper free list index included. If the system allows other writes to a region to proceed asynchronously and out of order, it is possible for an allocated region to contain a corrupted or incomplete message. In this case, the system associates checksum information with the message to detect this case and recover. In any event, message corruption will only occur in the event of a rare operating system failure or hardware crash.

Another disk writing strategy is possible and that is to flush a disk buffer cache at regular intervals to reduce the chances that a number of messages might be corrupted. Many operating systems do this as a matter or course and the present implementation does not provide this mode.

An RMS Message Store is a much simpler implementation of a Message Store. In one embodiment, the underlying operating system environment provides a Record Management System that has APIs similar to the following:

int index = addRecord(byte[ ] record)
deleteRecord(int Index)
byte[ ] getRecord(int index)

In this case, the implementation of a RMS Message Store is relatively trivial. The form of the QueueEntry 1702 would be reduced to that shown in FIG. 17.

In a Java implementation of a File Message Store, an empty Queue requires about 170 byes and a QueueEntry including the Region Descriptor requires about 40 bytes. In the example above, where the data store is required to store twenty 1 kilobyte messages for 100,000 devices about 17 megabytes are required for the 100,000 queues and 80 megabytes for the Queue Entries. On a dual CPU machine with 3.2 GHz CPUs and a fast RAID 5 SCSI disk array, a Message Queuing System using a Memory Message Store can store, en-queue, read and de-queue messages at about 85,000 messages per second. A Message Queuing System configured with a File Message Store can en-queue, read and de-queue messages at the rate of 3,500 messages per second.

In one implementation, the Mobile Communications Server is the KonaWare Server, available from KonaWare of Menlo Park, Calif. The KonaWare Server manages the communication between the mobile applications and backend enterprise applications. It supports asynchronous messaging, message encryption, guaranteed once and-only-once message delivery and message prioritization over multiple communication channels. All messages to and from devices can be logged for auditing purposes. The system is highly scalable and can be configured to handle a large set of message queues that can reach tens of thousands of mobile devices. The KonaWare Console is a Web-based system administration tool for the deployment and management of mobile applications.

The KonaWare Shuttle is the implementation of the Messaging Subsystem on mobile devices. It contains libraries that implement the Message Queuing System identical to those found in the KonaWare Server. A KonaWare Shuttle using the File Message Store is provided on devices that support .NET, .NET Compact Framework or Java operating environments. A KonaWare Shuttle using the RMS Message Store is provided in J2ME environments. As a result, mobile applications built with KonaWare are extensible across a continuum of mobile devices from smart phones to laptops. These applications are not browser-based or thin-client interfaces, but rather true multi-threaded applications with transparent offline and online functionality. The application interface and navigation can be optimized for each specific device type in order to provide the greatest usability and performance.

The KonaWare Shuttle ensures seamless off-line and on-line functionality for mobile applications by facilitating automatic network connection detection. All messages are queued locally and automatically sent wirelessly when network connectivity is available. This asynchronous delivery system ensures efficient transmission of data and a guarantee of “always there” data using two-way push/pull transmissions. In addition, the KonaWare Shuttle has built in mechanisms that detect message, device, and network settings so that performance is optimized depending on network availability.

While this invention has been described with reference to specific embodiments, it is not necessarily limited thereto. Accordingly, the appended claims should be construed to encompass not only those forms and embodiments of the invention specifically described above, but to such other forms and embodiments, as may be devised by those skilled in the art without departing from its true spirit and scope.

```
APPENDIX
/**********************************************************************
** Copyright 2001–2007 KonaWare, Inc. All rights reserved. Use of this
** Source Code is subject to the terms of the applicable license
** agreement from KonaWare, Inc.
**********************************************************************/
/**********************************************************************
** Note, this “code” is for illustrative purposes only and does not
** represent the actual implementation. Many details, such as
** supporting methods and exception handling have been omitted
** or simplified in the interests of clarity.
**********************************************************************/
package com. konaware.queuestore;
import java.util.Hashtable;
/**
* Implements a MessageStore which keeps all queued messages in memory.
* Nothing is stored in persistent memory.
*
* @author ahall
*/
public class MemoryMessageStore implements MessageStore {
    private Hashtable queueStore = new Hashtable( );
    public MemoryMessageStore( ) {
    }
    /**
    * Insert a Message into the MemoryMessageStore.
    * Returns the QueueEntry describing this Message.
    */
    public QueueEntry putMessage (Message message) {
        QueueEntry queueEntry =
            new QueueEntry(message.getMessageProperties( ),message);
        return queueEntry;
    }
    /**
    * Retrieve the message from the MemoryMessageStore.
    */
    public Message getMessage(QueueEntry queueEntry) {
        return (Message) queueEntry.messageHandle;
    }
    /**
    * Delete the message associated with the queueEntry
    * from the MemoryMessageStore.
    */
    public void deleteMessage (QueueEntry queueEntry) {
        queueEntry.messageHandle = null;
    }
    /**
    * Returns the Queue associated with the given name.
    */
    public Queue getQueue(String queueName) {
        Queue queue = (Queue)queueStore.get(queueName);
        if ( queue != null) return queue;
        queue = new Queue(queueName, this);
        queueStore.put(queueName, queue);
        return queue;
    }
    public void close( ) {
    }
}
public class Message {
    private Hashtable messageProperties = null;
    private byte[ ] messageBody = null;
    /**
    * Creates a Message from the byte array and initializes the
    * message properties.
    */
    public Message(byte[ ] msgBody) {
        messageBody = msgBody;
        messageProperties = new Hashtable( );
    }
    /**
    * Returns the byte array held within the message.
    */
    public byte[ ] getMessageBody( ) {
        return messageBody;
    }
    /**
    * There are 4 methods for setting integer, String
    * long and Date properties.
    */
    public void setXXXProperty(String name, int value) {
        . . .
    }
    /**
      * There are 4 corresponding methods for retrieving
      * integer, String, long and Date properties.
      */
    public XXX getXXXProperty(String name) {
        . . .
    }
    /**
    * There are 5 methods for getting the system properties:
    * Queue Name, Message ID, Time Stamp, Message Sequence #,
    * and Message Priority
    */
    public String getQueueName( ) {
        . . .
    }
    public int getMessageSeqNo( ) {
        . . .
    }
    public long getTimeStamp( ) {
        . . .
    }
    public String getMessageID( ) {
        . . .
    }
    public byte getMessagePriority( ) {
        . . .
    }
}
public class Queue {
    // Queue properties
    private String queueName = null;
    private MessageStore messageStore = null;
    private QueueEntry distinguishedQE = new QueueEntry( );
    private int size;
    // Last assigned messageID
    private static long messageID = 0;
    private int messageSeqNo = 0;
    // Object to hold synchronization mutex.
    private static Object msgIDMutex = new Object( );
    /**
    * Instantiate a Queue with a given name
    */
    Queue(String queueName, MessageStore queueStore) {
        this.queueName = queueName;
        this.messageStore = queueStore;
        distinguishedQE.next = distinguishedQE.prev = distinguishedQE;
    }
    /**
    * Add a Message to the tail of the queue.
    */
    public void addMessage (Message message, byte priority) {
        synchronized (this) {
            // Generate unique message ID
            . . .
            // Increment sequence number.
            messageSeqNo++;
            // Set the sequence number, message ID, priority and
            // queue name in the message.
            . . .
            // Add the message to the associated MessageStore.
            QueueEntry newEntry = messageStore.putMessage(message);
            // Add message to queue.
            QueueEntry qed = distinguishedQE.prev;
            for (; qed != distinguishedQE; qed = qed.prev) {
                if ( qed.priority >= priority) break;
            }
            addBefore(newEntry, qed.next);
        }
    }
    /**
    * Return the Message at the head of the Queue.
    */
    public Message peekMessage(int priorityThreshold) {
        synchronized (this) {
            for (QueueEntry qed = distinguishedQE.next;
                              qed != distinguishedQE;
                              qed = qed.next) {
                if ( qed.priority >= priorityThreshold) {
                    return messageStore.getMessage(qed);
                }
            }
            return null;
        }
    }
    /**
    * Remove the entry from the Queue with matching messageID.
    */
    public boolean deleteMessage(String messageID) {
        synchronized (this) {
            QueueEntry qed = findEntry(messageID);
            if (qed == null) return false;
            deleteEntry(qed);
            return true;
        }
    }
    /**
    * Return the number of entries in the Queue.
    */
    public int getSize( ) {
        return size;
    }
    /**
    * Find an entry in the queue with matching Message ID.
    * Return null if the Message ID is “null” or any
    * non-numeric String.
    */
    private QueueEntry findEntry(String messageID) {
        // Convert messageID to a long
        long delID;
        try {
            delID = Long.parseLong(messageID);
        } catch (NumberFormatException e) {
            return null;
        }
        // Find the matching queue entry, starting at the head
        // of the queue.
        for (QueueEntry qed = distinguishedQE.next;
                        qed != distinguishedQE;
                        qed = qed.next) {
            if (qed.messageID == delID) {
                return qed;
            }
        }
        return null;
    }
    /**
    * Generate a unique messageID
    */
    private long getMessageID( ) {
        . . .
    }
    /**
    * Add the QueueEntry, newEntry, before QueueEntry e.
    */
    private void addBefore(QueueEntry newEntry, QueueEntry e) {
        newEntry.next = e;
        newEntry.prev = e.prev;
        newEntry.prev.next = newEntry;
        newEntry.next.prev = newEntry;
        size++;
    }
    /**
    * Delete the QueueEntry qed.
    */
    private void deleteEntry(QueueEntry qed) {
        qed.prev.next = qed.next;
        qed.next.prev = qed.prev;
        qed.next = qed.prev = null;
        messageStore.deleteMessage(qed);
        size−−;
    }
    /**
    * Return the Message with matching messageID.
    */
    public Message getMessage(String messageID) {
        . . .
    }
    /**
    * Return the count of messages within a priority range
    */
    public int countMessages(int minPriority, int maxPriority) {
        . . .
    }
    /**
    * Returns a Message array that contains all the messages
    * currently in the Queue.
    */
    public Message[ ] peekAll( ) {
        . . .
    }
    /**
    * Removes all current entries from the Queue.
    */
    public void deleteAll( ) {
        . . .
    }
    /**
    * insertQueueEntry is provided for use by a MessageStore that
    * need to recreate Queues during initialization.
    *
    */
    public synchronized void insertQueueEntry(QueueEntry newEntry) {
        . . .
    }
    /**
    * Returns the name of the Queue.
    */
    public String getName( ) {
        return queueName;
    }
}
/**
* A QueueEntry contains the minimal amount of the information
* about a Message and the queue structure.
*/
public class QueueEntry {
    // The message priority of the message in this QueueEntry.
    byte priority = 0;
    // The message sequence number of the message in this QueueEntry.
    int messageSeqNo = 0;
    // The message ID of the message in this QueueEntry.
    long messageID = 0;
    // The messageStoreHandle holds a reference to the object
    // describing the location of the message in the MesasgeStore.
    // In the case of the FileMessageStore, this will be a
    // RegionDescriptor.
    // In the case of the MemoryMessageStore, this is the Message
    // itself.
    Object messageStoreHandle = null;
    // References to the “next” and “previous” QueueEntries.
    QueueEntry next = null;
    QueueEntry prev = null;
    /**
    * Create an empty QueueEntry
    */
    QueueEntry( ) {
    }
    /**
    * This constructor is provided for use by a MessageStore when
    * recovering Queues from persistent storage.
    */
    QueueEntry(KWMap msgProperties, Object messageHandle) {
        // copy priority, messageSeqNo and messageID from msgProperties
        // to this QueueEntry's properties
            . . .
        // copy the mesasgeHandle to the this QueueEntry.
        this.messageStoreHandle = messageHandle;
    }
}
```

What is claimed is:

1. A process to perform messaging among a plurality of mobile nodes, comprising performing one disk seek to en-queue, read or de-queue a predetermined short message; and performing two disk seeks to en-queue or read the predetermined long message.

2. The process of claim 1, wherein the size of predetermined short message comprises a configurable quantity, typically between approximately one kilobyte and four kilobytes.

3. The process of claim 1, wherein a message is stored in one or more contiguous blocks.

4. The process of claim 1, comprising keeping a data storage device a consistent state so that in case of program or operating system failure, the data store can be recovered.

5. The process of claim 1, comprising creating a data store in one or more files of a file system.

6. The process of claim 5, comprising using an operating system disk buffer cache.

7. The process of claim 1, comprising creating a data store on a raw disk partition.

8. The process of claim 1, comprising using a buddy system memory allocation.

9. The process of claim 8, comprising allocating space by removing an entry for a region from a free list of regions and marking the region as allocated.

10. The process of claim 9, comprising performing I/O operations to allocated regions in parallel.

11. The process of claim 9, comprising marking a block as allocated at the same time data is written into the region.

12. The process of claim 8, comprising de-allocating the region by marking the region as free and adding the region to the free list.

13. The process of claim 8, comprising storing a message in one or more contiguous disk blocks.

14. The process of claim 13, comprising minimizing the number of disk seeks required to write or read a message when using raw disk partitions.

15. The process of claim 5, comprising initializing the data store by examining each region in the data store.

16. The process of claim 15, comprising reconstructing a data object contained in an allocated region and alternatively adding the region to the free list if the region is unallocated.

17. The process of claim 1, comprising performing garbage collection

18. The process of claim 17, comprising combining buddy blocks in the free list into a larger block.

19. The process of claim 1, comprising providing only one consumer of a queue that invokes a peekFirst method to retrieve an entry and a deleteFirst method to remove the entry.
